(19) United States
(12) Patent Application Publication
(10) Pub. No.: US 2009/0015748 A1
(43) Pub. Date: Jan. 15, 2009

(54) Liquid crystal display device

(75) Inventors: Hideki Kujiraoka, Kanagawa (JP); Osamu Ohkanda, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC LCD TECHNOLOGIES, LTD, Kanagawa (JP)

(21) Appl. No.: 12/216,600

(22) Filed: Jul. 8, 2008

(30) Foreign Application Priority Data
Jul. 10, 2007 (JP) 181385/2007
May 16, 2008 (JP) 129264/2008

(51) Int. Cl. G02F 1/1333; G02F 1/13357

(52) U.S. Cl. 349/58; 349/69

(57) ABSTRACT

A liquid crystal display device includes a liquid crystal display panel and a light source consisting of a plurality of light emitting devices and the light emitting devices are divided into a plurality of groups, and each group's light emitting device is mounted on a different structural member, respectively.

### INCORPORATION BY REFERENCE

This application is based upon and claims the benefit of priority from Japanese Patent Application No. 2007-181385, filed on Jul. 10, 2007, and No. 2008-129264, filed on May 16, 2008, the disclosure of which is incorporated herein in its entirety by reference.

### BACKGROUND OF THE INVENTION

1. Technical Field

The present invention relates to a liquid crystal display device and in particular, relates to a liquid crystal display device having a backlight module.

2. Background Art

A liquid crystal display (LCD) device featured by a thin shape, a light weight, and low power consumption is used in a wide range of fields, such as OA (office automation) equipment, AV (audiovisual) equipment, and portable terminal equipment. The LCD device includes an LCD panel and a backlight module for illuminating the LCD panel which is composed by disposing a liquid crystal between a pair of transparent substrates. A solid state light emitting device such as light emitting diode (LED) and Electro-Luminescence (EL) device can be used for a light source of the backlight module, as well as a conventional lamp. In the case of using LEDs as a light emitting device of the backlight module, the LEDs would be destroyed by its temperature rise unless the heat generated in the LEDs is efficiently radiated. To this end, various heat radiating structures are proposed.

For example, an LED module is arranged in an end of a long side of a back frame of an LCD device, and a heat sink is contacted the back frame thermally in Japanese Patent Application Laid-Open No. 2006-267936.

Another LCD device provided with an LED backlight is disclosed in Japanese Patent Application Laid-Open No. 2006-064733. This LED backlight has a configuration that an LED light source and a first heat conduction elastic sheet are mounted on one face of an insulating substrate, and a second heat conduction elastic sheet and a heat sink substrate are arranged on other face thereof.

Japanese Patent Application Laid-Open No. 2006-039349 discloses another LCD device in which fluid with low fluidity is respectively disposed at a contact interface between a heat radiating sheet and an insulating substrate mounting an LED light source, and at a contact interface between a heat radiating sheet and a heat sink substrate.

On the other hand, an LED illumination light source using LEDs is disclosed in Japanese Patent Application Laid-Open No. 2006-049026. This LED illumination light source is provided with an insulating substrate with a plurality of first LEDs, and a transparent substrate with a plurality of second LEDs. The insulating substrate and the transparent substrate are arranged so as to oppose each other. Lights emitted from the first LEDs pass the transparent substrate and are emitted outside, and lights emitted from the second LEDs pass the transparent substrate after being reflected with the light reflectors installed in the insulating substrate and are emitted outside.

### SUMMARY

An exemplary object of the present invention is to provide an LCD device which can achieve a thin shape and a light weight even when a light emitting device such as an LED or: an Electro-Luminescence device is used as a light source.

An LCD device of an exemplary aspect of the present invention is an LCD device using a plurality of light emitting devices as light sources, in which the plurality of light emitting devices are divided into two or more groups and each group of the light emitting devices is mounted on a different structural member composing the LCD device, respectively.

### BRIEF DESCRIPTION OF THE DRAWINGS

Exemplary features and advantages of the present invention will become apparent from the following detailed description when taken with the accompanying drawings in which:

FIG. 1 is a perspective view of an LCD device according to a first exemplary embodiment of the present invention;

FIG. 2A is a cross-sectional view along a II-II line of FIG. 1;

FIG. 2B is a cross-sectional view of other part of FIG. 1;

FIG. 3 is a side view of the LCD device according to the first exemplary embodiment of the present invention;

FIG. 4A is a cross-sectional view along a line corresponding to the II-II line of FIG. 1 of an LCD device according to a second exemplary embodiment of the present invention;

FIG. 4B is a cross-sectional view of a part corresponding to other part of FIG. 1 of an LCD device according to a second exemplary embodiment of the present invention;

FIG. 5 is a side view of the LCD device according to the second exemplary embodiment of the present invention;

FIG. 6 is a cross-sectional view showing a structure of an LCD device according to a third exemplary embodiment of the present invention;

FIG. 7A is a cross-sectional view along a line corresponding to the II-II line of FIG. 1 of an LCD device according to a fourth exemplary embodiment of the present invention;

FIG. 7B is a cross-sectional view of a part corresponding to other part of FIG. 1 of an LCD device according to a fourth exemplary embodiment of the present invention;

FIGS. 8A and 8B are side views of LCD devices according to a fifth exemplary embodiment of the present invention;

FIG. 9A is a cross-sectional view along a line corresponding to the II-II line of FIG. 1 of an LCD device according to a sixth exemplary embodiment of the present invention;

FIGS. 9B and 9C are cross-sectional views of parts corresponding to other different parts of FIG. 1 of an LCD device according to a sixth exemplary embodiment of the present invention, respectively;

FIG. 10 is a cross-sectional view showing a structure of an LCD device according to a seventh exemplary embodiment of the present invention;

FIG. 11 is a perspective view of an LCD device according to an eighth exemplary embodiment of the present invention; and

FIG. 12 is a perspective view of an LCD device according to a ninth exemplary embodiment of the present invention.

### EXEMPLARY EMBODIMENT

Exemplary embodiments of the present invention will now be described in detail in accordance with the accompanying drawings.

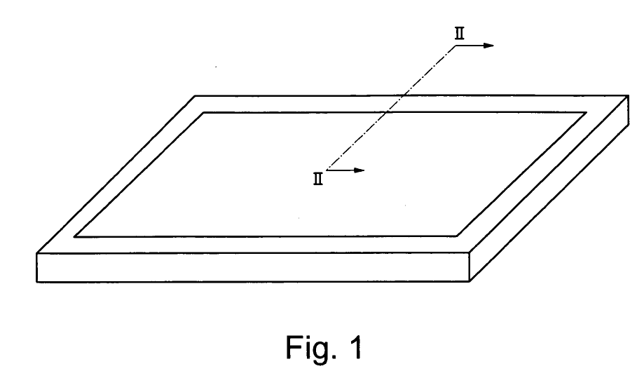

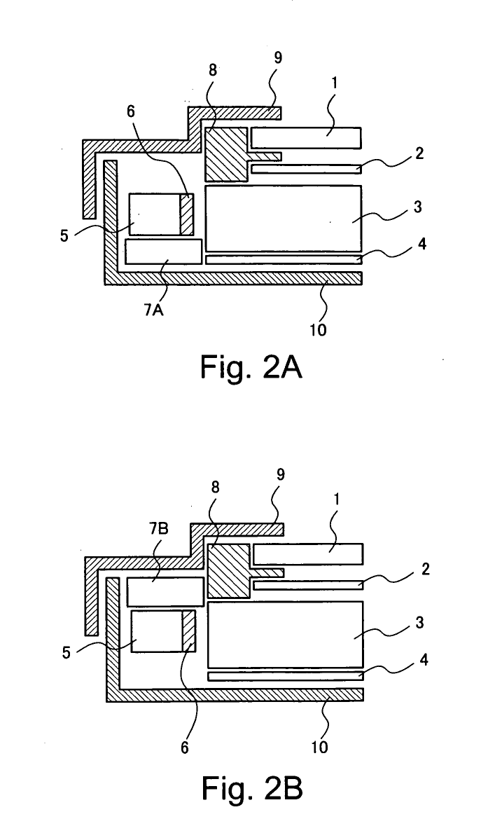

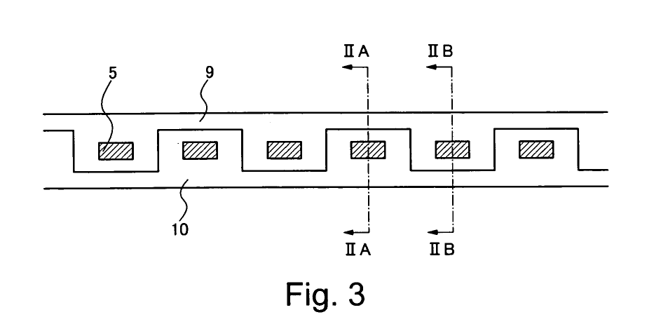

An LCD device according to a first exemplary embodiment of the present invention will be described with reference to FIGS. 1 to 3. FIG. 1 is a perspective view showing the LCD device according to this exemplary embodiment. FIG. 2A is a cross-sectional view along a II-II line of FIG. 1, and FIG. 2B is a cross-sectional view of other part of FIG. 1. FIG. 3 is a side view of the LCD device according to this exemplary embodiment.

As shown in FIG. 1, FIG. 2A and FIG. 2B, the LCD device according to this exemplary embodiment includes an LCD panel 1, a backlight module provided with a plurality of LEDs 5 as light emitting devices constituting a light source, and a housing provided with a front cover 9 and a rear cover 10 which are different structural members constituting the LCD device.

As shown in FIG. 3, the plurality of LEDs 5 are divided into two groups, for example, and the LEDs 5 of each group are mounted on the front cover 9 as a first structural member, and the rear cover 10 as a second structural member respectively. By adopting such a configuration, heat generated in each light emitting device is radiated, respectively from the plurality of structural members on which the light emitting devices are mounted. Thereby, radiating area per unit number of the light emitting device expands and radiation performance of a backlight module increases. As a result, a conventional heat-radiating member, such as a heat sink acting as a hindrance to miniaturization and weight saving of an LCD device, can be miniaturized or omitted in the LCD device according to this exemplary embodiment.

Next, the LCD device according to this exemplary embodiment is explained more in detail by referring to FIG. 1 and FIG. 2A. The LCD panel 1 is provided with a TFT substrate in which switching elements, such as TFTs (thin film transistors), are arranged in matrix form, and a counter substrate in which a color filter, a black matrix, etc. are formed, and is provided with a liquid crystal disposed between their substrates. The backlight module includes an optical sheet 2, such as a polarizing sheet arranged at a rear-face side of the LCD panel 1, an array of LEDs 5, a wiring board 7A in which a drive circuit of the LED 5, etc. are formed, a light guide plate for guiding light emitted from the LEDs 5 all over LCD panel 1, a reflecting sheet 4 for reflecting the light leaked from a rear-face side to the LCD panel 1. And the LCD device is provided with a chassis 8 for holding the LCD panel 1 and the backlight module, and a housing including the front cover 9 and the rear cover 10. The LEDs 5 are mounted on the wiring board 7A, and the wiring board 7A is bonded on the rear cover 10.

As shown in FIG. 2B, a different part of FIG. 2A, the LEDs 5 are mounted on the wiring substrate 7B, and the wiring substrate 7B is bonded on the front cover 9.

That is, the LCD device of this exemplary embodiment is provided with a plurality of light emitting devices acting as a light source on the lateral side of the light guide plate. And the plurality of light emitting devices are divided into two groups, the first group's light emitting devices are mounted on the first structural member for holding the LCD panel from a display surface side, and the second group's light emitting devices are mounted on the second structural member for holding the LCD panel from a rear-face side thereof. The first group's light emitting devices can be mounted on the first structural member in an internal surface of the LCD device.

A side view of the LCD device mounting the LEDs 5 therein is typically shown in FIG. 3. Cross-sectional views along lines of IIA-IIA and IIB-IIB of FIG. 3 correspond to FIG. 2A and FIG. 2B, respectively. As shown in FIG. 3, the LCD device of this exemplary embodiment is characterized in that a plurality of LEDs is mounted on the front cover 9 and the rear cover 10 alternately. That is, all LEDs 5 are not mounted on one wiring board, but they are mounted alternately on the wiring board 7A adhered to the rear cover 10 which is a back side housing and the wiring board 7B adhered to the front cover 9 which is a display surface side housing. In the LCD device of this exemplary embodiment, the light emitting devices of each group can be arranged on each structural member corresponding to each group in one line along the longitudinal direction of an internal surface of the LCD device.

Heat generated from the LEDs 5 mounted on the front cover 9 is radiated in the air from the front cover 9 via the wiring board 7B. On the other hand, heat generated from the LEDs 5 mounted on the rear cover 10 is radiated in the air from the rear cover 10 via the wiring board 7A. Therefore, since a heat radiation area for the LEDs becomes large compared with the configuration with which all the LEDs 5 are mounted on one wiring board, the heat radiation efficiency of the backlight module can be improved. That is, in the packaging structure of the LEDs 5 of this exemplary embodiment, the heat from the LEDs 5 can be radiated outside efficiently, without newly adding a heat sink, a heat conduction elastic sheet, a radiation sheet, etc. Thereby, in this exemplary embodiment, a thin shape and lightweight LCD devices are realizable.

In this embodiment, radiation efficiency of the backlight can be improved and temperature rise of the light emitting devices can be suppressed, and thus decline in both lifetime and luminance of the light emitting devices can be suppressed. In this embodiment, since more light emitting devices can be mounted compared with conventional one, luminance of the backlight and the LCD device can be improved.

In contrast, even if the LCD devices of the related technologies described in the background art install the heat radiation members, temperature rise of LEDs cannot be suppressed sufficiently due to its structural restriction. Therefore, since the lifetime of LEDs becomes short and the number of mounting of LEDs is restricted in the LCD device according to the related art, it would be difficult to make luminance of the LCD device high.

Further, in the LED illumination light source according to the related art (Japanese Patent Application Laid-Open No. 2006-049026) described in the background art, in order to secure the optical path for emitting the emitted light from the LED outside via the light reflector, it is necessary to arrange two substrates mounting the LEDs so that they may oppose by a predetermined gap. Therefore, this LED illumination light source is difficult to be miniaturized, and there was a problem of not being employable in the light source of an LCD device characterized by a thin shape and a light weight.

Only the structure of one side of the LCD device is shown in FIGS. 2A and 2B. Regarding arrangement of the LEDs 5, which would be arranged not only on one side of the LCD device, but also on both sides thereof. Although a case when LEDs 5 are employed as a light source is shown by this exemplary embodiment, this exemplary embodiment can also be applied similarly to a light source using other kinds of light emitting devices such as an Electro-Luminescence device.

Although the material of front cover 9 and rear cover 10 is not limited in particular, since the front cover 9 and the rear cover 10 are utilized for the radiation of the heat generated in the LEDs 5 to the outside, it is desirable to form them with a good thermally conductive metal. Method for fixing the wiring boards 7A and 7B is not limited in particular, either. However, the wiring boards 7A and 7B may be fixed to the rear cover 10 or the front cover 9 by using a good thermally conductive adhesive or by screwing so that the heat generated in the LEDs 5 can be efficiently transmitted to them via the wiring boards 7A and 7B.

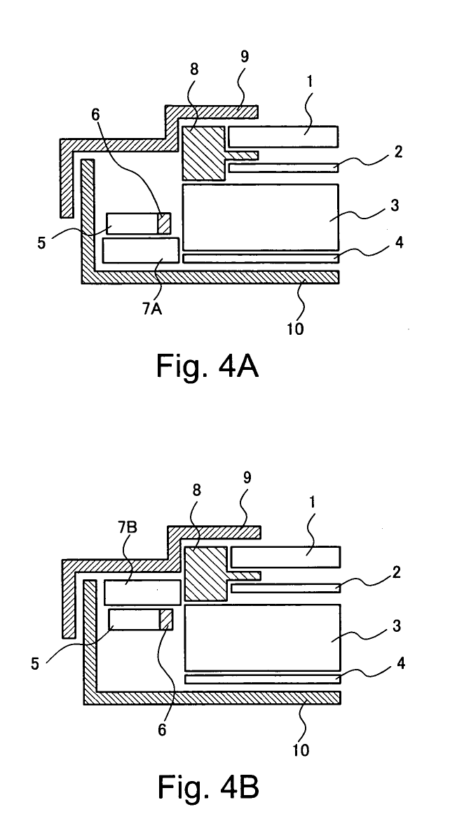

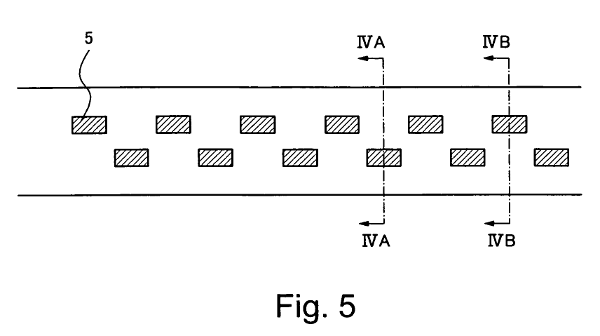

Next, an LCD device according to a second exemplary embodiment of the present invention will be described with reference to FIG. 4A, FIG. 4B and FIG. 5. FIG. 4A is a cross-sectional view along a line corresponding to the II-II line of FIG. 1. FIG. 4B is a cross-sectional view of a part corresponding to other part of FIG. 1. FIG. 5 is a side view of the LCD device of this exemplary embodiment.

In the above-mentioned first exemplary embodiment, the LEDs 5 are arranged in one line or on a straight line, but the arrangement of the LEDs 5 is not restricted to this. According to this embodiment, as shown in FIG. 5, the LEDs 5 are arranged in two lines separating from each other or on a zigzag line. As shown in FIG. 4A corresponding to the cross-sectional view along a IVA-IVA line of FIG. 5, the wiring board 7A mounting the LEDs 5 by the side of the rear cover 10 is fixed to the rear cover 10 so that the LEDs 5 thereon may become the lower line of the two lines. As shown in FIG. 4B corresponding to a cross-sectional view along a IVB-IVB line of FIG. 5, the wiring board 7B mounting the LEDs 5 by the side of the front cover 9 is fixed to the front cover 9 so that the LEDs 5 thereon may become the upper line of the two lines.

That is, in the LCD device of this exemplary embodiment, a plurality of light emitting devices are arranged in plural lines or on a zigzag line along with a longitudinal direction of side of the LCD device, and a plurality of groups of the light emitting devices can constitute each line.

Thus, in this exemplary embodiment, radiation effect of the heat generated in the LEDs 5 can be improved further. Therefore, in this exemplary embodiment, the mounting number of the LEDs 5 can be increased more and the luminance of backlight and the LCD device can be improved further.

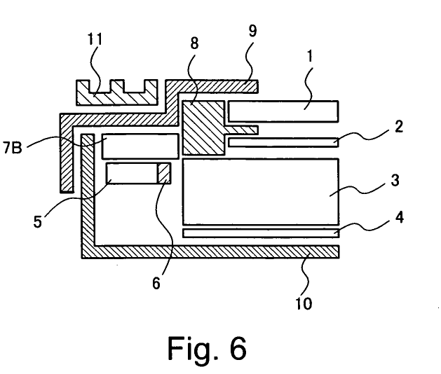

Next, an LCD device according to a third exemplary embodiment of the present invention will be described with reference to FIG. 6, which is a cross sectional view showing a structure of an LCD device according to this exemplary embodiment.

According to the first and the second exemplary embodiments mentioned above, the heat transmitted via the wiring board 7B is radiated only by the front cover 9. In contrast, the LCD device of this exemplary embodiment is provided with a small heat sink 11 attached to the front cover 9 in addition to the structure of the first or the second exemplary embodiment mentioned above. As a result, the radiation performance of the front cover 9 can be improved further. Of course, it is also possible to attach a heat sink to the rear cover 10, and it is also possible to attach heat sinks with different shapes and different radiating effects to both the front cover 9 and the rear cover 10. The position that attaches a heat sink is not limited in particular, either.

Thus, difference in a radiating effect may arise in the front cover 9 and the rear cover 10 by attaching radiating members, such as a heat sink, to either or the both sides of the front cover 9 or the rear cover 10. Even in this case, since the temperature rise of the LED 5 attached to the front cover 9 and the temperature rise of LEDs 5 attached to the rear cover 10 can be equalized, the generation of luminance unevenness according to the difference in the temperature rise of the LEDs 5 can be suppressed. However, radiating members, such as a heat sink of this exemplary embodiment, are a thing for adjusting the radiation ability of the front cover and the rear cover, or a thing for improving radiation ability as a whole. Therefore, in this exemplary embodiment, it is the same as the first and the second exemplary embodiment that the LCD device can be miniaturized compared with conventional one as a whole. In order to adjust heat radiation ability, it is not limited to the configuration mentioned above, and a material of a different radiation characteristic may be used for each of the front cover and the rear cover.

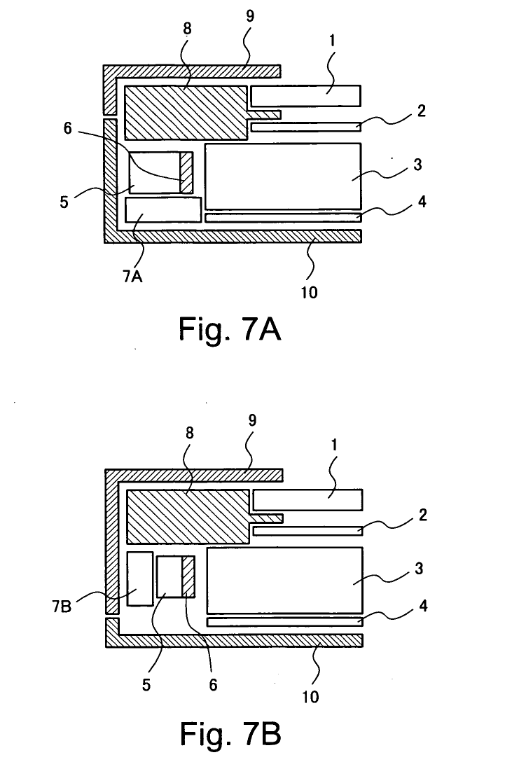

Next, an LCD device according to a fourth exemplary embodiment of the present invention will be described with reference to FIG. 7. FIG. 7A is a cross-sectional view along a line corresponding to the II-II line of FIG. 1. And FIG. 7B is a cross-sectional view of a part corresponding to other part of FIG. 1.

The structure where the wiring board was fixed to the display surface and the rear face of the housing was shown in the first to the third exemplary embodiment mentioned above. In contrast, in this exemplary embodiment, two kinds of LEDs, a side view type (a packaging surface is orthogonal to the emission face of light) and a top view type (an emission face of light is an opposite side of a packaging surface), are used. That is, as shown in FIG. 7B, a wiring substrate 7B with LEDs of the top view type is fixed on a side of a front cover 9.

That is, in the LCD device of this exemplary embodiment, different types of light emitting devices can be used such as side view type light emitting devices and top view type light emitting devices.

According to the first to the third exemplary embodiments, in order to adjust the emission face of the LED 5 with the light guide plate 3, the mounting position of the wiring board 7B were adjusted by bending the front cover 9. However, according to this exemplary embodiment, there is no necessity for such adjustment, and thus flexibility of a design increases.

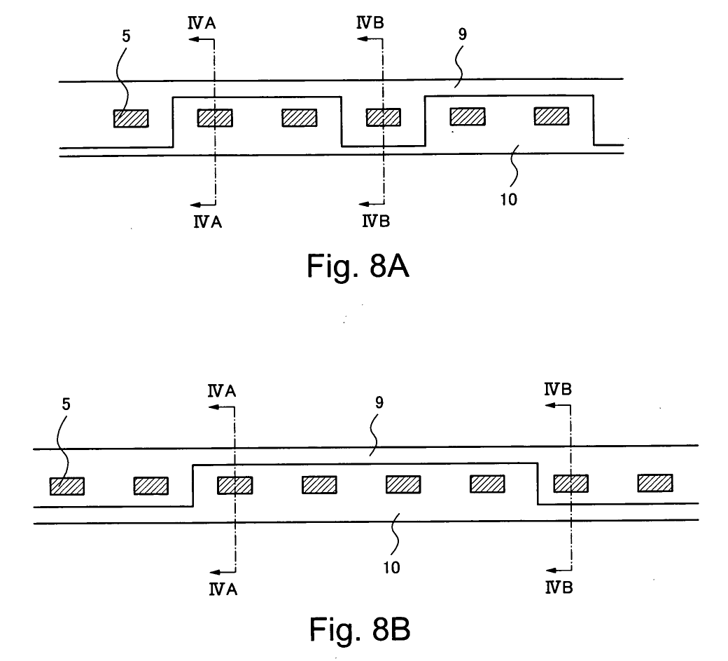

Next, an LCD device according to a fifth exemplary embodiment of the present invention will be described with reference to FIGS. 8A and 8B, which are side views of LCD devices according to this exemplary embodiment.

In the first exemplary embodiment mentioned above, as shown in FIG. 3, the LEDs 5 mounted on the front cover 9 and the LEDs 5 mounted on the rear cover 10 were arranged alternately. In contrast, in this fifth exemplary embodiment, the number of LEDs 5 mounted on the front cover 9 or the rear cover 10 as a structural member is determined according to radiation ability of the structural member for mounting each LED 5. That is, the number of LEDs 5 mounted on each structural member is set up so that temperature rise of each LED 5 thereon may become uniform. Thereby, lifetime of each light emitting device can be equalized and luminance unevenness thereof can be suppressed.

In this exemplary embodiment, for example, as shown in FIG. 8A, the ratio of the number of the LEDs 5 mounted on the front cover 9 to that on the rear cover 10 can be made to ½. As shown in FIG. 8B, central LEDs 5 may be mounted on one housing (e.g., rear cover 10) and LEDs 5 in an edge may be mounted on other housing (e.g., front cover 9). In this case, the same kind of LEDs can be used for the central LEDs 5 and the LEDs 5 in the edge. According to this exemplary embodiment, the mounting configuration of the LED is not limited to the above-mentioned configuration, but can also use two or more kinds of LEDs with different thermal resistance and different power consumption by adjusting the number of the LEDs 5 mounted in each housing thereof.

That is, in the LCD device of this exemplary embodiment, each group's light emitting devices can be repeatedly arranged in turn to each corresponding structural member in different quantity for every group. In the LCD device of this exemplary embodiment, a plurality of light emitting devices are arranged in one line along the longitudinal direction of the internal surface of the LCD device, and a plurality of groups of light emitting devices can be made a configuration including one group of light emitting devices in a central portion in the longitudinal direction thereof and other group of light emitting devices in edge portions in the longitudinal direction thereof. In the LCD device of this exemplary embodiment, a plurality of light emitting devices can be made a configuration including two or more kinds of light emitting devices with different thermal resistance or different power consumption.

The LCD device of this exemplary embodiment further includes an edge light type backlight provided with a light source and a light guide plate for entering a light emitted from the light source from the side thereof, and for emitting it from an upper surface thereof. The LCD device of this exemplary embodiment is provided with a plurality of light emitting devices constituting a light source, and two or more structural members for mounting the light emitting devices. And each structural member has radiation performance corresponding to heat generated from a mounting light emitting device, and the light emitting device is arranged so that an emission face thereof may oppose to a side of a light guide plate mostly.

As stated above, in this exemplary embodiment, each of the LEDs 5 is arranged according to the radiation performance of the front cover 9 and the rear cover 10. As a result, because temperature rise of the LEDs 5 can be made uniform in this exemplary embodiment, it is possible to make the luminance lifetime of each LED equal, and suppress luminance unevenness thereof. In this exemplary embodiment, even when using two or more kinds of light emitting devices from which thermal resistance and power consumption differ together, two or more kinds of those light emitting devices are mounted on a different structural member, respectively, and radiation ability of each structural member is adjusted so that lifetime of each light emitting device may become equal.

In consideration of radiation structure of the LCD device according to this exemplary embodiment and an apparatus for mounting it, it also becomes possible to adjust number of mounting and mounting position of light emitting devices to each structural member. For example, when the LCD device according to this exemplary embodiment and the apparatus mounting it are fixed via a front cover, radiation efficiency can be improved by increasing the number of mounting of the light emitting devices on the front cover.

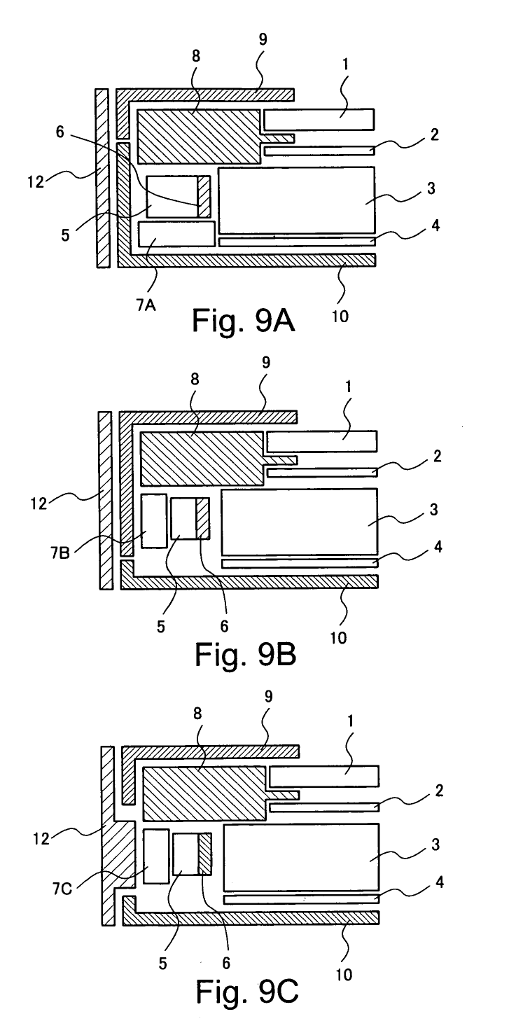

Next, an LCD device according to a sixth exemplary embodiment of the present invention will be described with reference to FIGS. 9A-9C. FIG. 9A is a cross-sectional view along a line corresponding to the II-II line of FIG. 1. FIGS. 9B and 9C are cross-sectional views of parts corresponding to other different parts of FIG. 1.

According to the first to the fifth exemplary embodiment mentioned above, the structural members for mounting the LEDs 5 are the front cover 9 as the first structural member and the rear cover 10 as the second structural member. In contrast, in the sixth exemplary embodiment, LEDs 5 are mounted on three kinds of structural members including a side cover 12 as a third structural member in addition to the front cover 9 as the first structural member and the rear cover 10 as the second structural member. A wiring board 7C on which the LEDs 5 are mounted is fixed on the side cover 12 as shown in FIG. 9C.

That is, the LCD device of this sixth exemplary embodiment provides the side thereof with a plurality of light emitting devices divided into three groups serving as a light source. The first group's light emitting devices are mounted on a first structural member for holding the LCD device from a display surface side. The second group's light emitting devices are mounted on a second structural member for holding the LCD device from a rear-face side. And the third group's light emitting devices are mounted on a third structural member arranged at the side of the LCD device.

The structural members for mounting the LEDs 5 are not limited to three kinds, but four or more kinds may be available.

According to this exemplary embodiment, finer control of radiation ability of the backlight module can be performed. As a result, temperature rise of the LEDs 5 can be controlled more precisely and uniformly, and luminance lifetime of each LED can be made equal, and luminance unevenness of the LEDs 5 can be suppressed.

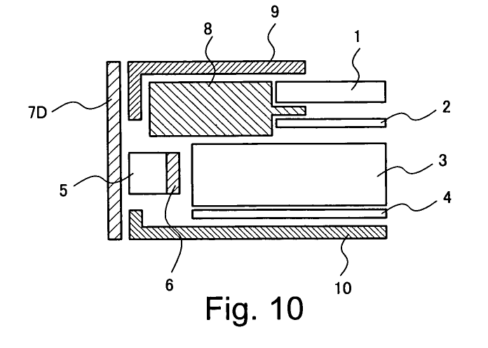

Next, an LCD device according to a seventh exemplary embodiment of the present invention will be described with reference to FIG. 10, which is a cross sectional view showing a structure of the LCD device according to this exemplary embodiment.

This exemplary embodiment is characterized in that the side cover 12 used in the sixth exemplary embodiment is formed by a metal core wiring board 7D. According to the sixth exemplary embodiment, thermal resistance may arise between the wiring board 7C and the side cover 12. In contrast, in this exemplary embodiment, since a side cover is formed of a wiring board 7D as shown in FIG. 10, thermal resistance does not arise. Therefore, in this seventh exemplary embodiment, radiation performance of the backlight module can be increased. In this exemplary embodiment, since the number of structural members can be reduced, cost cut of an LCD device is achieved.

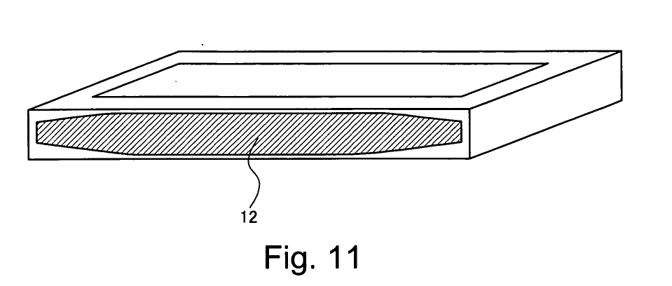

Next, an LCD device according to an eighth exemplary embodiment of the present invention will be described with reference to FIG. 11, which is a perspective view of an LCD device according to this exemplary embodiment.

According to this exemplary embodiment, a width of a side cover 12 as a structural member arranged on a side of an LCD device is thin at edge portions thereof compared with a central portion. Generally, because the edge portions are closer to a case than a central portion and radiating areas of the edge portions are larger than that of central portion, LEDs 5 in a central portion become hotter than other LEDs 5 at edge portions. Therefore, the LEDs 5 at the central part have a tendency for a luminance lifetime to become short compared with the LEDs 5 located at the edge portions, and luminance of the light emitting device of the central portion falls by prolonged use to cause luminance unevenness. In contrast, in this exemplary embodiment, radiating area in the central portion of the side cover 12 is made large compared with that of the edge portions. Therefore, the temperature rise of each LED 5 mounted on the side cover 12 can be made uniform, and the luminance lifetime of each LED is made equal and luminance unevenness thereof can be suppressed.

That is, the LCD device of this exemplary embodiment is the LCD device including a plurality of light emitting devices as a light source, and the plurality of light emitting devices are mounted on the structural member arranged in the side of the LCD device, and the width of the structural member is changing along the longitudinal direction of the side thereof. According to this eighth exemplary embodiment, the width of the longitudinal direction of a structural member is wide at the central portion, and narrow at the edge portions.

In contrast, in the edge light type LCD device according to the related art described in the background art, when a lot of LEDs are arranged near one side of the light guide plate, temperature rise at the central portion where LEDs exist on both sides is high compared with that at the edge portions where each LED exists only on one side. And in the edge light type LCD device of a related art, since a luminance lifetime also has a tendency for the central portion to become short similarly, the luminance of the central portion falls compared with the end by prolonged use to cause luminance unevenness.

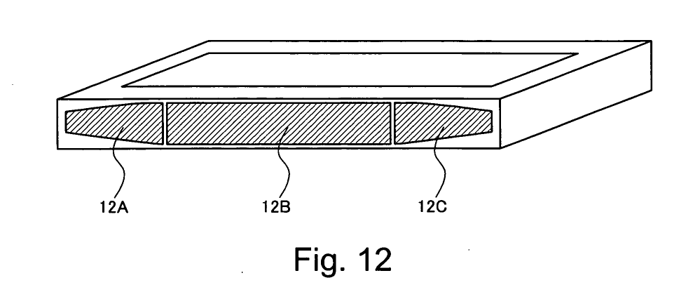

Next, an LCD device according to a ninth exemplary embodiment of the present invention will be described with reference to FIG. 12, which is a perspective view of an LCD device according to this exemplary embodiment.

According to this exemplary embodiment, the side cover 12 in the eighth exemplary embodiment is divided into three of side covers 12A, 12B, and 12C, and an area of heat radiation of a central portion is made large compared with those of the edge portions thereof.

That is, in the LCD device of this exemplary embodiment, the structural member is divided into the longitudinal direction, and light emitting devices are mounted on each structural member to form groups thereof. And the area of each structural member may be set up so that the heat generated in the light emitting device per unit area may become larger at the edge portions than the central portion.

Thereby, in the LCD device of this exemplary embodiment, the effect described in the eighth exemplary embodiment can be realized more certainly.

The present invention has the feature in the mounting structure of the light source of the LCD device, and other components, for example, a structure, a construction material, a shape of the LCD panel 1, the optical sheet 2, the light guide plate 3, and the reflecting sheet 4, etc., are not limited in particular. For example, an IPS (In Plane Switching) system, a TN (twisted nematic) system, or a VA (vertical alignment) system may be adopted as the LCD panel 1, and a TFT (thin film transistor) or a TFD (thin film diode) may be adopted as a switching element, and a staggered type or an inverted staggered type may be adopted also as the structure of the TFT.

Although each above-mentioned exemplary embodiment shows the case where the LEDs 5 are used as the light emitting devices to form a backlight, the present invention is not limited to the above-mentioned exemplary embodiment, and the present invention can apply similarly to a backlight source using a light emitting device whose lifetime and luminance are changed by temperature rise.

Although each above-mentioned exemplary embodiment shows the case where the structure of the present invention is applied to the LCD device, the present invention is applicable similarly to an arbitrary apparatus provided with a heating element for which heat radiation is needed.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

Further, it is the inventor's intention to retain all equivalents of the claimed invention even if the claims are amended during prosecution.

What is claimed is:

1. A liquid crystal display device, comprising:
a liquid crystal display panel; and
a light source including a plurality of light emitting devices, said light emitting devices being divided into a plurality of groups such that said groups are mounted on a different structural members, respectively.

2. The liquid crystal display device according to claim 1, further comprising a light guide plate for receiving emitted light from said light source to enter from a side surface thereof and outputting said emitted light from an upper surface thereof,
wherein each of said structural members has a heat radiation performance corresponding to a produced heat by said light emitting device mounted thereon, and said light emitting device is arranged so that an emission face thereof may oppose to said side surface of said light guide plate.

3. The liquid crystal display device according to claim 1,
wherein said light emitting devices are divided into a first group and a second group, and said structural members includes a first structural member and a second structural member for holding said liquid crystal display panel from a front-face side and a rear-face side thereof, respectively,
wherein said first group and said second group of said light emitting devices are mounted on said first structural member and said second structural member, respectively.

4. The liquid crystal display device according to claim 1,
wherein said light emitting devices are divided into a first group, a second group and a third group, and said structural member includes a first structural member and a second structural member for holding said liquid crystal display panel from a front-face side and a rear-face side thereof, respectively, and a third structural member provided at a side of said liquid crystal display panel,
wherein said light emitting devices of said first group, said second group, and said third group of said light emitting devices are mounted on said first structural member, said second structural member, and said third structural member, respectively.

5. The liquid crystal display device according to claim 3,
wherein said first group of said light emitting devices is located on an internal side surface of said first structural member.

6. The liquid crystal display device according to claim 1,
wherein said light emitting devices are arranged on a line along a longitudinal direction of an internal surface of said liquid crystal display device, and said light emitting devices in each of said groups are arranged alternately on each of said structural members.

7. The liquid crystal display device according to claim 1,
wherein number of said light emitting devices arranged differs in each said structural member, respectively.

8. The liquid crystal display device according to claim 1,
wherein said light emitting devices are arranged on a line along a longitudinal direction of an internal side surface of said liquid crystal display device and said plurality of groups include groups of said light emitting devices arranged in a central portion and an edge portion in a longitudinal direction thereof, respectively.

9. The liquid crystal display device according to claim 1,
wherein said light emitting devices are arranged on a zigzag line along a longitudinal direction of a side surface of said liquid crystal display device, and said groups of said light emitting devices are located on said line, respectively.

10. The liquid crystal display device according to claim 1,
wherein said structural member includes a structural member arranged on a side of said liquid crystal display device such that a width thereof changes along with a longitudinal direction thereof.

11. The liquid crystal display device according to claim 10,
wherein said width of said member is wide at a central portion thereof in said longitudinal direction and small at an edge portion thereof in said longitudinal direction.

12. The liquid crystal display device according to claim 10,
wherein said member is divided by a longitudinal direction and forms a plurality of divided structural members, and said groups of light emitting devices are mounted on said divided structural members, respectively.

13. The liquid crystal display device according to claim 12,
wherein each area of said divided structural members are designed such that heat generated in said light emitting devices per unit area at edge portions is larger than that in said light emitting devices at a central portion of said divided structural member.

14. The liquid crystal display device according to claim 1,
wherein said light emitting devices include two or more kinds of light emitting devices from which thermal resistance or power consumption differs.

15. The liquid crystal display device according to claim 1,
wherein said light emitting devices include a light emitting device of the side view type and a light emitting device of the top view type.
